(19) United States
(12) Patent Application Publication
(10) Pub. No.: US 2020/0374483 A1
(43) Pub. Date: Nov. 26, 2020

(54) SYSTEMS AND METHODS AND APPARATUSES FOR CAPTURING CONCURRENT MULTIPLE PERSPECTIVES OF A TARGET BY MOBILE DEVICES

(71) Applicant: CFKK, LLC, Beverly Hills, CA (US)

(72) Inventors: Leonard Kleinrock, Beverly Hills, CA (US); Yu Cao, Hangzhou (CN); Martin Charles Kleinrock, Mount Pleasant, SC (US)

(21) Appl. No.: 16/990,627

(22) Filed: Aug. 11, 2020

Related U.S. Application Data
(62) Division of application No. 15/226,464, filed on Aug. 2, 2016, now abandoned.
(60) Provisional application No. 62/200,028, filed on Aug. 2, 2015.

(51) Int. Cl. H04N 5/77; H04L 29/06; H04L 29/08; H04N 7/18; H04N 5/232; H04N 9/82

(52) U.S. Cl. CPC H04N 5/77; H04L 67/42; H04L 67/12; H04N 7/181; H04N 5/23238; H04N 5/23203; H04N 5/23216; H04N 9/8205; H04N 5/23206; H04N 5/23222

(57) ABSTRACT

Systems, methods and apparatuses utilize multiple, independent sensing devices to collaboratively gather sensing data. A server or one of the sensing devices receives information which is used to select a target, and the device commences gathering sensing data of a target. The server or the device then solicits other devices to provide additional perspectives of the target. The other devices can solicit still other devices, in a cascading or other fashion. The concurrent, multiple perspectives thus gathered are provided to a collector, and can be mosaicked or otherwise stitched together.

This application is a divisional of U.S. patent application Ser. No. 15/226,464 filed Aug. 2, 2016, titled “Systems and Methods and Apparatuses for Capturing Concurrent Multiple Perspectives of a Target by Mobile Devices”. U.S. Ser. No. 15/226,464 claims priority to U.S. provisional application Ser. No. 62/200,028 filed on Aug. 2, 2015, titled “Methods and Apparatus For A Market For Sensor Data”. U.S. 62/200,028, U.S. Ser. No. 15/226,464 and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the inventions is collaborative coupling of sensing devices.

### BACKGROUND

The following description includes information that may be useful in understanding the present inventions. It is not an admission that any of the information provided herein is prior art or relevant to the presently claimed inventions, or that any publication specifically or implicitly referenced is prior art.

More than ever, massive amounts of data are collected every moment and in nearly every place. Smart, sensor-laden devices are proliferating around the world, and especially in developed countries. Smartphones are the most obvious example, reprehensive of proliferation of data.

Crucially, current infrastructure and economic deficits mean that this proliferation of smart devices is accompanied by un- and under-utilized sensors. Consumers are purchasing smartphones on a regular schedule, leaving millions of increasingly powerful smart phones completely unused. Simultaneously, rapid increases in computing power is driving the price of new devices such as powerful smartphones down to below USD $40.

Other smart sensor devices are following this same path. Smart watches and other fitness trackers, for example, are beginning the obsolescence cycle in which smart phones have already spent a decade.

The example of smartphones and other smart devices is only a fragment of the sensor data that will be generated by the emerging Internet of Things (IoT), in which billions of smart and often sensor-laden devices will be connected to the Internet.

This emerging world of smart devices amidst a broader IoT is taking place amongst an undeniable recognition that there is great utility to the massive collection and processing of sensor and other data. Both corporate and government investments in large-scale infrastructure to this effect are testimonies to this fact. From security to public health, sensor data is an integral part of modern life in the developed and developing world.

It is known in some instances for self-mobilized devices (miniature robots, for example) to autonomously collaborate to achieve some objective. But most IoT sensors (including for example cell phones and wearable electronics) are not self-mobilized. They might well be moved about by a human, or be attached to a motor vehicle, but they cannot move about on their own. There still seems to be no easy way for non-self-mobilized sensor devices to autonomously collaborate to capture concurrent multiple perspectives of a target.

There are systems in which multiple cameras are arranged by location, and the camera angles, durations and other aspects coordinated by one or more individuals in a control room. Examples include multiple TV cameras situation about a sporting event. This method does not solve the problem because the collaboration is human driven rather than autonomous.

A “poor man's” alternative system is exemplified by the CamSwarm™ mobile app, which is said to mimic the “bullet time” effect popularized by the 1999 film The Matrix. There, a large number of cell phones or other cameras are positioned in a semi-circle about a target being filmed. Each camera operates independently under the control of a human operator, although each of the human operators is more or less controlled by whomever is coordinating the shoot.

Periscope™ is a more sophisticated system, in which anyone with a cell phone and the Periscope app can live-stream whatever is around them. The system is similar to that described above in that a viewer, nearby or halfway across the world, can make suggestions to the person taking the live stream (what to film, what camera angles, and so forth). iPhone users have had this capability for several years with FaceTime™, which has been used to view homes or autos for sale, to provide images of clothing or other goods to house bound shoppers, etc.

A still more sophisticated system is TapThere™, which is on the market, but has not yet become popularized. TapThere allows viewing individuals to tile multiple views from different live-streaming cameras, which can be selected from potentially thousands of available streams.

Despite the sophistication of Periscope and TapThere, it is still unknown for the non-self-mobilized devices (the cell phones in those cases) to coordinate among themselves to figure out what target to image, and how to arrange the cameras in an appropriate manner to capture concurrent multiple perspectives of the target. Instead there is always a human that selects the targets, and either directly or indirectly controls the cameras.

In some embodiments, the numbers expressing quantities of ingredients, properties such as concentration, reaction conditions, and so forth, used to describe and claim certain embodiments of the inventions are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventions are approximations, the numerical values set forth in the specific examples are reported as precisely as practicable. The numerical values presented in some embodiments of the inventions may contain certain errors necessarily resulting from the standard deviation found in their respective testing measurements.

As used in the description herein and throughout the claims that follow, the meaning of “a.” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the inventions, and does not pose a limitation on the scope of the inventions otherwise claimed. No language in the specification should be construed as indicating any non-claimed element essential to the practice of the inventions.

Groupings of alternative elements or embodiments of the inventions disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for systems and methods in which non-self-mobilized sensor devices autonomously collaborate to decide upon a target, and then capture concurrent multiple perspectives of the target.

### SUMMARY OF THE INVENTION

The inventive subject matter provides apparatus, systems and methods in which non-self-mobilized sensor devices autonomously collaborate to decide upon a target, and then capture concurrent multiple perspectives of the target.

Consider the case of gathering sensing data for a boxing practice session. The session is divided into two periods. During the first period, a boxer (“boxer X”) is coached by a coach, and during the second period, boxer X has a bout with the second boxer (“boxer Y”). For beneficial effects, sensing data including images, videos, audios, and limb movements are gathered. Multiple sensing devices work together to do the gathering. A stationery camera (“device A”) stands by on premise. When certain conditions are met, device A starts video recording, such met conditions include: a specific time has arrived, a motion is detected by a motion detector attached to device A, or a human pushes a button on device A. In order to have additional perspectives and additional data during the session, the coach uses a mobile phone (“device B”) that captures video and audio of boxer X. Both boxer X and boxer Y have wearable sensing devices (“device C” and “device D” respectively) that capture their limb movements. At the end of the session, data from all devices are submitted to a collector. The data can then further processed and rendered.

With aspects of the current inventive subject matter, the scenario above is enhanced so that collaborative gathering with amounts of autonomy is deployed in collecting concurrent, multiple perspectives of the session. Device A is mounted in guide rails near the arena, and the starting of recording is determined as describe above, namely when a certain condition is met, or a human commands the device. During the first period of the session, device A, being networked with device B, solicits device B to record the session. Device B being carried by a person has more leeway in choosing a location and angle when conducting video recording and audio recording. Device B, which happens to be a mobile phone, contains software which provides advice on moving in relation to the center of the arena. In one conceived embodiment, the software gets real-time images that is gathering by device A, compares the images from device A and images from device B itself, and calculates needed movement of device B, so that a quality measure that is partially based on the images from device A and the images from device B is improved. Meanwhile, device A receives advice from device B so that device A moves along the guide rail. Further, device C and device D are solicited by device A so that limb movements of boxer X and boxer Y are sensed, and data gathered in time. Device C and device D and advised by device A during the session so that limb movements are gathering at changing resolutions so as to balance storage, battery, data quality for device C and device D.

In preferred embodiments, at least one of the devices obtains information. The information can be obtained in any suitable manner, including for example from a human user, or a non-human source, such as a sensor on the information obtaining device. The information can be a condition to be met, for example, a schedule time has arrived, for another example, a device has moved into an area. The information can also be the desire to capture sensing data. The device then uses the information to commence a session of data gathering relative to a target, which in preferred embodiment refers to an object, an event, or a scene. That device or a server electronically networked with the device, then solicits other devices to collaborate in capturing the other perspectives of the target. To facilitate such collaboration, the mobile devices in preferred embodiments are organized so that from time to time each device notifies a server of its then-current availability, capability, and location.

One very important aspect of the inventive subject matter is that “collaborative gathering” of data is carried out by devices where spatial mobility is being controlled by a human. Thus, a cell phone is included as a mobile device herein when someone is carrying it around on his/her person. Similarly, a DLSR camera can be a mobile device herein when it is being carried about by a human, positioned on the dashboard of an automobile being driven about by a human, or for example when the camera is being positioned on a slider or dolly. As yet another example, a flying drone is included as a mobile device of the inventive subject matter when its spatial movements are being are controlled by a human On the other hand, devices of the inventive subject matter exclude self-mobilizing robots, e.g., Gizmodo™, BigDog™, Asimo™, and auto swarming robots, when decisions regarding movements of the robots are being made entirely under their own control.

In some contemplated embodiments, at least one of the various contacting and contacted mobile devices is either a cell phone or some other electronic device having a telephony (voice transmitting and receiving) capability.

During a typical session, contemplated collaborative gathering of mobile devices involves at least two aspects. One aspect is the spatial aspect. The gathering could be about an object, or multiple objects across a scene, or multiple objects across a large area. The other aspect is the temporal aspect, in which an event unfolds. The gathering, however, doesn't necessarily arise to recognition. For example, during a session a device gathers audio that contains barking and talking, but the device is not aware of the fact that the session contains dogs and humans.

The collaboration is particularly important to improve the quality of gathered data. Consider a session where device A takes pictures of a person. A second device (“device B”), an audio recording device, can collaborate, and gather the perspective of the person's talking. Thus pictures from device A and audios from device B, together improve the quality of the gathered data on the person during the session. Now consider that device C, a mobile phone, is solicited, upon which device C gathers video from an additional perspective of the person in an angle and distance different from those of device A. Thus, pictures from device A, audios from device B and videos from device C supply different perspectives and together improve the quality of the gathered data.

An underlying principle of the contemplated systems, methods and apparatuses is dynamic resource sharing, namely, that in the prior art, the mass of computational power, network resources, and potential sensor data is largely unused, and that the inventive subject matter described herein will permit dynamic sharing of those resources.

In a typical embodiment, a commencing device, described herein as device A, commences a session, and solicits mobile device B to help. Device B in turn can solicit another mobile device, thus forming a solicitation cascade. At least one of these other devices agrees to these solicitations, and provides its/their perspective(s) of the target. There are numerous six contemplated permutations for each solicited device. A solicited device could (1) actively or passively agree to provide a perspective, or (2) actively or passively decline to provide a perspective, and in each case either solicit or not solicit another device to participate. In any event, it is contemplated that the actions of the various contacting and contacted devices can be autonomous, i.e., the devices might or might not be subject to full control by another of the devices.

Contacting of the other devices can be accomplished in any suitable manner, and either substantially concurrently (real time or near real time), or asynchronously. Thus device A might contact device B, and then 1, 2, 5, 10 minutes later (or with some other lag) contact device C. It is also contemplated that the contacting could be done by a server other than one of the perspective providing devices.

Irrespective of when the other devices are contacted to provide their additional perspectives, the various solicited mobile devices can provide their information to the collector concurrently, or in any suitable sequence or time frame. For example, it is contemplated that a dash cam on an automobile might “see” a car accident, and solicit additional perspectives from dash cams in nearby automobiles. The various perspectives from the other dash cams can then be received by a collector, and then mosaicked by the collector or some other device. In another example, a cell phone being used by a participant in a birthday party might “see” someone blowing out a birthday cake, and solicit additional perspectives from nearby cell phones. Such solicitation might be initiated by the user of the soliciting cell phone, or might be initiated by the soliciting cell phone autonomously from its human user. As in the other example, the various perspectives from the various cell phones could then be received by a collector, and then mosaicked, stitched together in a 3D virtual reality image, or combined in some other manner by the collector or some other device.

Besides just soliciting additional perspectives from other devices, the soliciting device can have other interactions with the other devices. For example, solicited device B might advise a different solicited device, device C, that device B has agreed to provide an additional perspective. Or that device B has declined to provide an additional perspective. Similarly, one or more of the various devices, or the server or collector, might communicate with one or more other devices to change angle, distance, or other aspect of their perspective(s). As another example, one or more of the various devices, or the server or collector, might communicate with one or more other devices to provide information about funds that can be earned by providing their additional perspectives, or perhaps to negotiate a fee. As yet another example, device A advises device B on the value of the data on device B, for example, device A might advise device B that the past M seconds of video that has been captured by device B is valuable judged by device A, and the future N seconds of video will also be valuable. As a further example, device A advises device B that at a future time, device B should be present at a certain location and capture audio data of the surroundings.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a flowchart depicting contemplated steps of the method for devices collaborating.

FIG. 2 is a collection of representations of some contemplated targets.

FIG. 3 is a schematic showing spatial relationships among multiple devices A, B, C, and D, a server, and two targets.

FIG. 4 is a table listing capacities of at least one of the devices of FIG. 1.

FIG. 5 is a flowchart depicting a contemplated series of collaborative interactions between device A and at least another of the devices of FIG. 1.

FIG. 6 is a flowchart depicting contemplated steps in managing problems associated with availability of devices B, C of FIG. 1.

FIG. 7 is a flowchart depicting contemplated steps in managing problems associated with capacities of devices A and B of FIG. 1.

FIG. 8 is a flowchart depicting contemplated steps in networking devices A and B of FIG. 1.

FIG. 9 is a flowchart depicting contemplated steps in processing data at the collector of FIG. 1.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

One should appreciate that the technical effects include software: (1) that contains a human-machine interface with various settings so that humans can provide information to devices; (2) that enables a soliciting device to distinguish “interesting” events, situations, objects, scenes, time intervals, spatial areas that warrant soliciting other devices to provide additional perspectives, from non-interesting ones; (3) that autonomously enables the soliciting device to identify and solicit various mobile devices; (4) that advises a solicited device how to provide their own additional perspectives, for example, to advise a device which direction to point to, how long the audio recording should last; (5) that includes mobile apps installed on phones; (6) that manages scarcity in a device's capacities in communication, storage, battery life, and mobility; (7) that manages the transmission of data between a device and a server and (8) that works with the server and a collector, for example, an interface for querying the gathered data.

Such software could be completely or partially resident on a device, or completely or partially resident on a different device, or completely or partially resident on the server, or completely or partially resident on the collector.

One should also appreciate that the technical effects include combining such software with hardware, so that making middleware and/or microchips.

One should further appreciate that the technical effects include a piece of hardware, preferably in the form of a dongle, that is to be combined with a second piece of hardware which is coupled with a sensing device, examples of such coupling include a selfie stick for mobile phone, a slider-dolly for camera, a guide wire for a mini-camera to be inserted into human body. The combination provides autonomous mobility to sensing devices. During a session of gathering sensing data, the dongle with its built-in computation and communication capabilities comes up with instructions to the second piece of hardware which moves a sensing device for good quality of gathered data.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

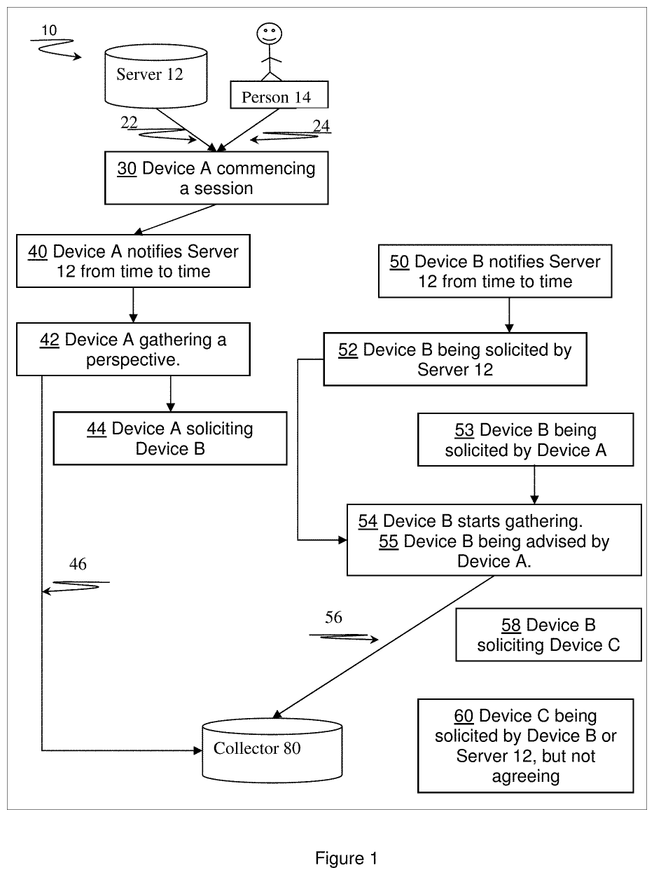

FIG. 1 is a flowchart depicting contemplated steps of the methods for devices collaborating. With method 10, a server 12 at step 22 gives information to device A; alternatively, person 14 at step 24 gives information to device A. Information can be obtained in any suitable manner, including for example from a human user, or a non-human source, such as a sensor on the information obtaining device. The information can be a condition to be met, for example, a schedule time has arrived, or as another example, device A has moved into a specific area. The information can also be an indicator that something interesting has happened. At step 30, device A starts a session of data gathering, the gathering being for an object, an event, or a scene, as suggested by the information received.

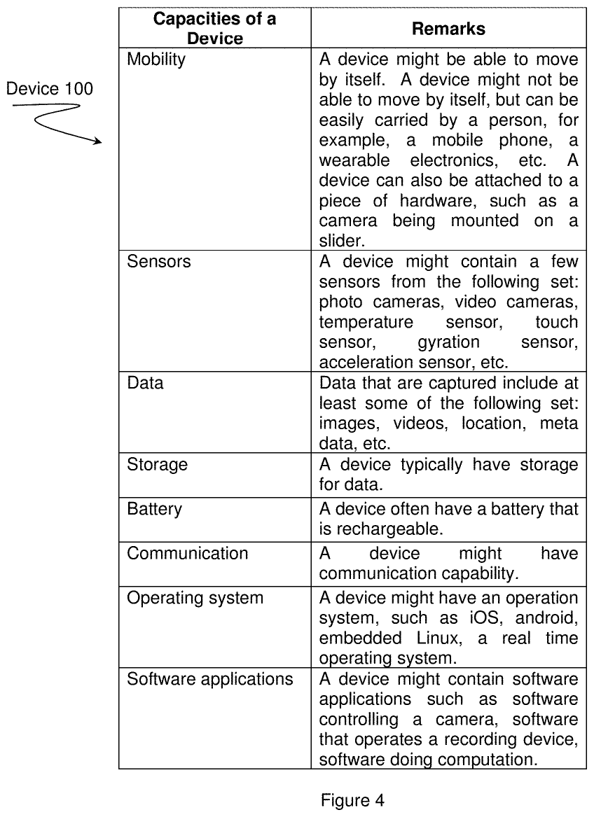

At step 40, device A from time to time informs its location, availability, and capabilities to server 12. Similarly at step 50, device B does the same. The devices and server are networked, so that information on location, availability, and capabilities of devices can be transmitted to the server. The server in turn transmits the information of a device to other devices. In FIG. 4, more on the location, availability, and capabilities of a device is depicted.

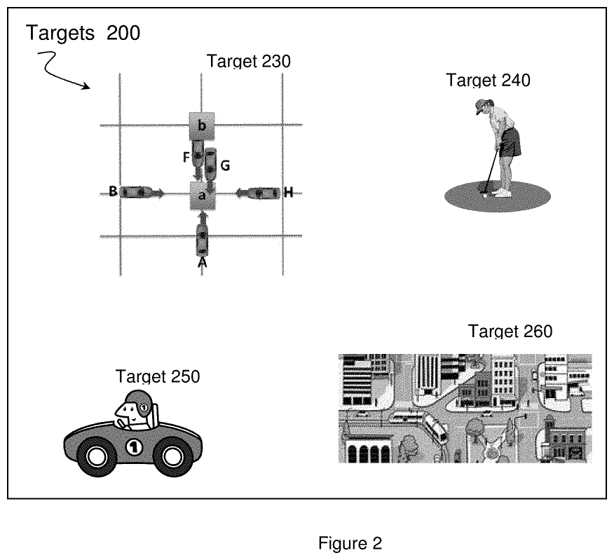

At step 42, device A gathers sensing data, such data forms a perspective of what is being captured. At step 54, device B also gathers sensing data, providing an additional perspective. In FIG. 2, more on the perspectives is depicted.

Device A by either peer-to-peer communication, or through a server, finds out whether there are at least one mobile device (referred to as device B without loss of generality) that can help, based on the known availability, capability, and location. Once solicited by device A, device B chooses to help for the next during of time. It is also determined by device A or the server that device B indeed is able to provide perspectives in addition to those that can be captured by device A.

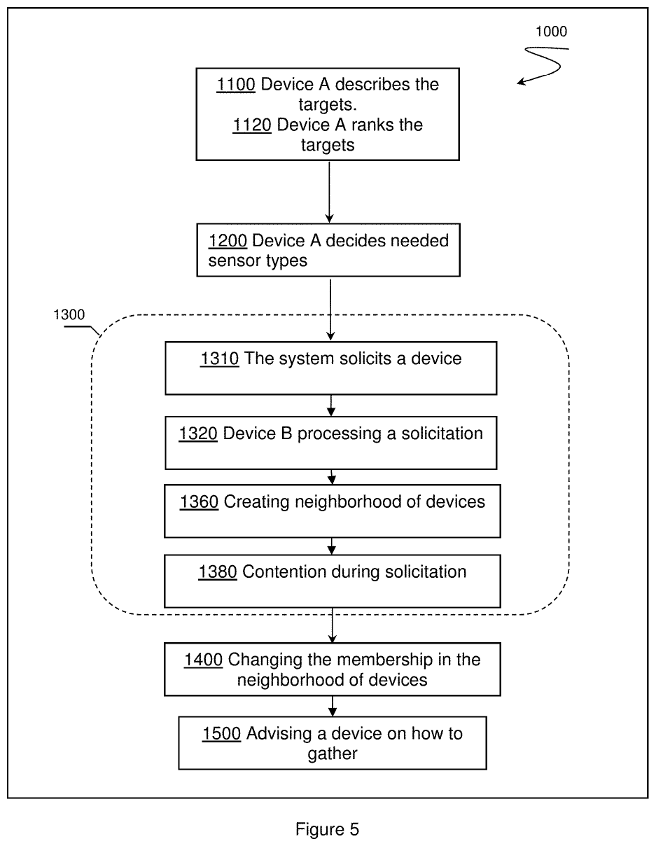

Specifically, at step 44, device A has been made aware of the availability of device B, and device A solicits device B to start gathering sending data, thus providing additional perspective. The solicitation can be sent directly from device A to device B, or alternatively, the solicitation is sent from device A to server 12, which in turn sends it to device B. At step 53, device B receives the solicitation from device A. Further, server 12 can by itself initiate a solicitation that solicits device B, thus at step 52, device B receives server 12's solicitation. Either through step 52 or step 53, device B receives a solicitation, and at step 54, device B agrees to the solicitation, and starts gathering data. While device B is gathering data, it becomes aware of device C, and at step 58 device B solicits device C. At step 60, device C receives the solicitation from device B, but does not agree to the solicitation. More on solicitations among the devices and the server is depicted in FIG. 5.

At step 55, device B is being advised by device A on gathering, in order for device B to achieve good quality in providing the additional perspective. Such advice broadly falls into the category of location, settings for sensing, and utilization of capabilities; a piece of advice could be moving to another location, panning the camera, pointing the camera to certain directions, changing settings of audio recording, among other possibilities.

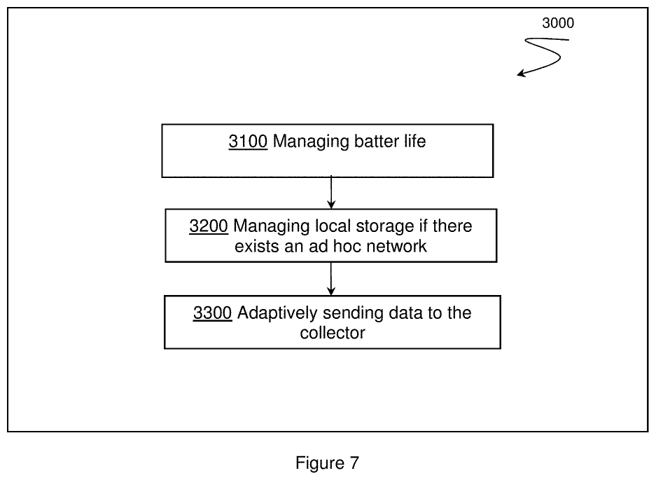

At step 46 and step 56, device A and device B respectively provide their perspectives to collector 80. Such providing can be done through streaming, or alternatively, by transmitting data at appropriate time so that bandwidth is used economically. Such management is further depicted in FIG. 7.

FIG. 2 is a depiction of different kinds of targets. As used herein, the term “target” refers to an object, an event, or a scene, from which sensed data can be collected, and of which data can be observed from multiple perspectives. For example, contemplated targets include animate objects of all kinds, including for example people or other animals, and inanimate objects of all kinds, including for example very large structures such as galaxies and stars, mountains, bridges or buildings, and a street intersection, smaller objects such as automobiles, bicycles, telephones, speakers, printers, birthday cakes, furniture, and even much smaller objects such as grains of sand, dust particles, atoms and molecules which are visualizable through a microscope. To demonstrate the wide breadth of contemplated types of targets, a target could be a changing scene at a street intersection (i.e. a defined environment), or a mobile or immobile object, such as a vehicle or building, respectively. As other examples, the target could be a car involved in an on-going accident, a celebrity spotted in a street, a person's leg being monitored for sweating by microchips, or a fire being monitored by a number of drones plus a number of CCTV cameras.

As used herein the term “multiple perspectives” is used in a broad sense to include different visual angles, different distances, different time frames, different frequencies, multiple objects, changing membership of a set of objects, and an event such as a conference, a concert, changing scenes of a city block, a person's life events across a period of time.

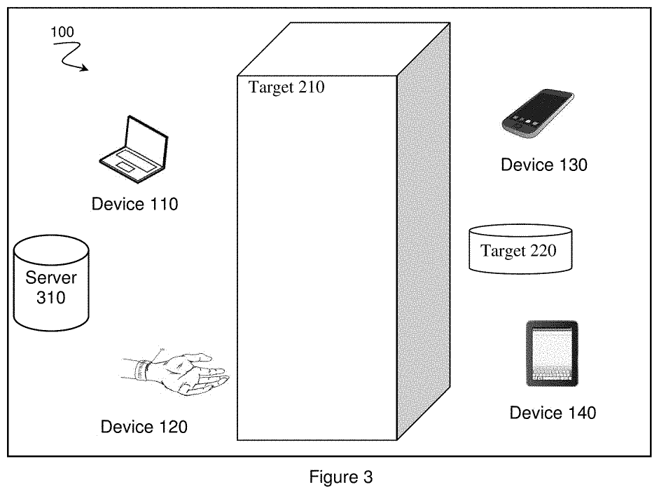

FIG. 3 is a schematic showing spatial relationships among multiple devices A, B, C, and D with a server. In system 100, several devices are capable of communicating with each other and with the server, every device having at least one sensing capability. A goal is to capture concurrent, multiple perspectives of target 210. Another goal is to do the same for target 220. Target 210 is relatively much larger than a device, to the point that a device, given its relative location to target 210, cannot sense the entirety of target 210. On the contrary, target 220 is compatible with at least one device, so that the device can sense the entirety of target 220.

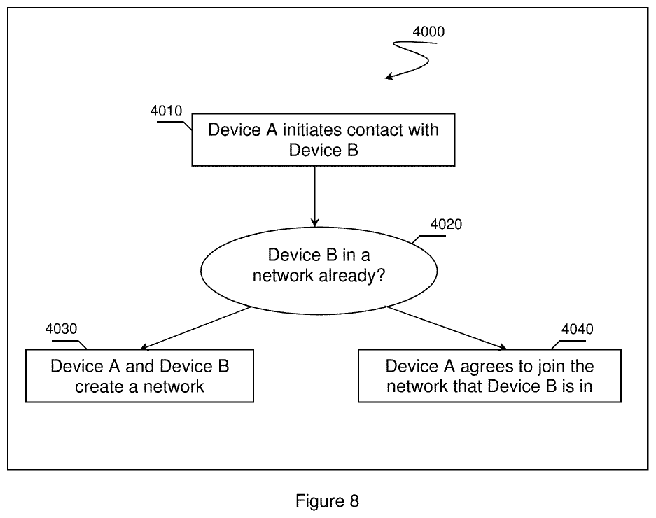

It should be appreciated that reference to four particular devices A, B, C and D in the claims and elsewhere in this application refers to any set of at least four devices coupled together in an ad-hoc network. The designation “ad-hoc” is intended to distinguish the networked devices of the claims herein from devices that are usually coupled together, as for example in a hardwired surveillance system of a factory. More is depicted on forming the ad hoc network in FIG. 8.

It should be appreciated that a typical device has an owner, and owners might agree, a priori, to enter into financial transactions regarding the devices' data gathering as well as the data that have been gathered.

In one preferred embodiment, a mobile phone is mounted on the dashboard of a moving car, and at some point, a person pushes a button on the mobile phone, and the phone starts recording video of the road ahead. Upon seeing an event of interest, the person pushes another button, and a solicitation is sent to the server. The server in time finds a pedestrian nearby holding a phone, and solicits the person to gather video using the phone for a period of time. Data gathered by both phones are sent to a collector.

In one preferred embodiment dubbed “sticks for 3D selfies”, a person holds 2 contemplated selfie sticks, each stick has a mobile phone mounted. A stick has a slider, and the mounted phone can move along the slider. The stick also is couple with a software application, thus is able to communicate with the phone to receive instructions on sliding motions. The person provides information to the first phone, which commences a session of taking of photos of the person. The first phone solicits the second phone, which agrees to the solicitation and starts taking photos. The first phone advises the second phone on moving for certain amounts of distance, and the second phone instructs the slider on its stick to move the distance. After a period of time, the gathering of data is done, and the second phone sends photos to the first phone which acts at a collector.

In another embodiment, a soldier behind a dirt wall is having a firefight with enemies. On the dirt wall there are two guns, each mounted on a slider, and a video camera that is mounted on a tripod. The solider gives information to the camera, so that the camera starts gathering video. The camera from time to time gives the two sliders instructions on how to move so that the guns are more effective in where to shoot.

In one contemplated embodiment, a mini-camera with a guide wire is inserted into a human blood vessel, the camera providing near real-time ultrasound images (Reference: “Single-chip CMUT-on-CMOS front-end system for real-time volumetric IVUS and ICE imaging”), and there is also an optical imaging device that works on the skin of a human. A person gives information to the optical imaging device, and it commences the gathering of images. During a session, the optical imaging device solicits the mini-camera, and the mini-camera agrees to the solicitation, and provides perspectives inside a blood vessel. The optical imaging device on the skin further advises the mini-camera where to go inside the vessel.

In one embodiment, with the game Pokémon GO™, upon its initial release, each player is independent except for the case of teams in gyms; even in gyms, there is no “cooperative” action, but rather each player is “on his own” using his/her Pokémons to do battle in the gym or to shoot at the Pokémon outside the gym. So with the contemplated system, suppose a player is in MacDonald's and she is trying to capture a Pokémon. She can send out a solicitation to some other players in the same MacDonald's™ who agree to join her in forming what we call a “pack” to capture the Pokémon. If one's pack is successful, one somehow shares that Pokémon, probably in some kind of fractional split based on how much one participated in capturing the Pokémon.

FIG. 4 lists capacities and other features of the sensing device.

In one preferred embodiment, a device is sometimes mobile but cannot move by itself. As used herein, the term “mobile device” means something other than a self-mobilizing robot as current typified by products such as Gizmodo, BigDog, and Asimo. As used herein mobile device can mean “hand carryable electronics having a visual sensor, and wireless network communication capability”, including for example a cell phone. Such a hand carryable weighs less than 20 lbs. Mobile device also means “flying electronics having has a visual sensor, and wireless network communication capability”, including for example a drone. Mobile device also means “wearable electronics having a sensor, and wireless network communication capability”, including for example an Apple watch, for another example a microchip implanted into the muscle.

Mobility is also provided by hardware that is attached to the device, for example, a slider-dolly provides mobility to a DSLR camera, for another example, a guide wire provides mobility to a mini-camera that goes inside a human's blood vessel.

A device is equipped with at least one sensing capabilities. A note on the sensors: typically a sensor has also “actuators”. Consider a video camera. While its main sensor is about capturing video images, there are “actuators” that control the pan, zoom, and other actions.

It has been contemplated a catalog of types of sensors, the catalog includes but is not limited to: (1) all sensors fall under the category of the Internet of Things (see Wikipedia pate on “Internet of Things”), (2) “dumb” sensors, (3) angular position sensors, (4) sensors for position sensing, (5) sensors for angle sensing, (6) infrared sensors, (7) motion sensors, (8) gyros, (9) accelerometers, (10) magnetometers, (1) Geiger counters, (12) seismometer, (13) the Light Detection And Ranging (LIDAR) sensor; (14) heart-rate sensor; (14) blood pressure sensor, (15) body temperature sensor, and (16) temperature sensor.

It has been contemplated a catalog of devices where sensors reside, the catalog includes but is not limited to: mobile phones, PCs, “android PCs”, drones, airplanes, wearable devices, video cameras such as CCTV and GoPro™, Lab-on-a-Chip (LOC), dash cams, and body cams.

It has been contemplated a catalog of the environments for a sensor, the catalog includes but is not limited to: underground, in the air, outer space, a moving person/mammal/insect/car, robots, inside a biological body. (Quoting Abundance by Peter Diamandis, “humans will begin incorporating these technologies into our bodies: neuroprosthetics to augment cognition; nanobots to repair the ravages of disease; bionic hearts to stave off decrepitude”).

It has been contemplated a catalog of the “viewsights”/“fieldviews”, the catalog includes but is not limited to: (1) a bird's eyes' view: e.g., CCTV's view, e.g. that of a factory floor, that of an intersection of roads, that of a parking lot, that of a driveway of a home, a large portion of a city, a shipping route, a patrol area, (2) the view by a panorama camera, (3) the view by a “ball, 360-degree” camera, (4) a line in the 4 dimensional space: e.g., data captured by Fitbit™, which is largely the movement on the ground of a dot over time, (5) the view by a nano-sensor, (6) the view by a gastro scope, (7) the view by GoPro mounted on someone's head, (8) the view by a telescope, (9) the view by geo-stationary satellites, (10) the view by crowd-funded micro-satellites.

It has been contemplated the range of data types available through system, the range includes but is not limited to: A sensor operates at a particular segment of the “scale of the universe”. While several prominent embodiments of the inventive subject matter are concerned with scales of the human body, objects that humans handle, the cities, the atmosphere, the oceans, and the continents, it is also true that scales smaller and larger are of relevance to the inventions, 10⁻⁹ meter gets us past DNA to around a water molecule; 10⁹ meters is a larger field than the Earth and thus covers whatever satellite data. In terms of understanding “events,” this range might actually put us in the business of “phenomena.” [Reference: The Scale of the Universe: Zoom from the edge of the universe to the quantum foam of spacetime and learn the scale of things along the way]

The term “data” means at least the following: metadata, data content, captured data, submitted data, the outputs from various types of processing performed. It has been contemplated a catalog of captured data and submitted data, the catalog includes many types of data as follows, but is not limited to the following: (1) Video, audio, scanned (and recognized, tagged) images, photos; (2) Smell, touch, pressure, temperatures, humidity, gestures; (3) Fluid flow, air flow; (4) Data at existing sites or owned by government agencies or other institutions. Many government agencies own a lot of data that can be made available to the public. Such agencies and the data they own include but are not limited to geographic information on underground water, underground pipes (e.g., pipes beneath a city), oceanic data, weather, data captured by CCTV (closed-circuit Television) monitors, crime reports, and a vast array of epidemiological data published by national health and other research organizations. Also many sites house a lot of data generated by the public. Such sites and the data on the sites include but are not limited to Yahoo Flickr™, YouTube™ Instagram™, Facebook™, and Twitterr™. Further, any large enterprises own a lot of data. Such enterprises and their data include but are not limited to oil fields (e.g., readings of the temperatures of a rig); (5) “Life cycles”: such as the video/picture of a tree (or a mouse) over a long period of time; (6) Epidemiological health data: such as aggregate heart-rate or blood pressure data, infection rates; (7) Longitudinal data on populations detected movement within spaces (i.e. movement of an individual or individuals) for the purposes of health and/or sleep tracking; (8) Human-generated data, including but not limited to chat messages (on Skype™, Line™, Whatsapp™, Twitter, Facebook, WeChat™, QQ™, Weibo™), web pages, novels, film, video, images, scanned photos, paintings, Songs. Speeches, News accounts, news reporting.

A device typically has storage that is local to it, thus it is capable of storing certain amounts of data.

A device often has a battery that is rechargeable. When unplugged, the battery has limitation in supply power, and sometimes, when battery is low, the device's capabilities deteriorate.

A device might also has communication capacities, which could be any from the following set: wi-fi, Near Field Communication, 3G mobile networks, 4G mobile networks, WiMAX, Bluetooth, CDMA, TDMA, GSM, GPRS, ZigBee, power line communication.

A device might also contain an operating system, which could be any from the following set: iOS™, Android™, embedded Linux, a real-time operating system.

A device might also be installed software applications, such as a mobile app, software that controls a camera, software that operates a recording device, software that does computation, and software that manages the device's storage.

FIG. 5 illustrates systems and methods 1000 for devices collaborating in order to accomplish the goal of capturing concurrent, multiple perspectives of a target.

Step 1100 is where a device describes the target. The description including both characteristics innate to the target and those not innate to the target. Among the former group are the location, direction, size, sensed nature (such as its color, and whether it makes noise). Among the latter group includes the duration of the session of gathering data, the value of the target. The value of the target could originate from the initial information that kicks start the gathering, from the device, or from the collector.

Step 1120 is where the device ranks targets when there are at least two targets, so that the device can decide which target to focus on. First, whether two targets are compatible is evaluated, namely to a device, capturing an perspective of one target does not stop it from capturing an perspective of another target, for example, two targets are in similar positions within the viewfield of a video recording device, for another example, one target requires gathering of video and another target requires audio recording, which means a video recording device can serve both targets. Second, the device can rank targets based on to what extent the device can do a good job at capturing data. In one embodiment, ranking is done by weighted sum of scores for factors include the distance to the target, the feasibility of moving closer, and the device's remaining battery life.

Step 1200 is determining what types of sensory data are needed in order to do a good job capturing the perspectives of a target. One contemplated method is setting up a pre-determined knowledge base, which lists needed sensory data in a default setting as well as in enumerated knowledge. A contemplated default setting is for a device to request the same types of data that the device itself is capable of sensing. Another contemplated default setting is for the devices to capture as many types of sensory data as possible, some of these types are complementary in nature to what is being captured by device A. For example, when device A captures photos, complementary types include audio recording, GPS readings, speed readings, a sensor capturing air sample, and a sensor capturing text messages.

Some of the contemplated pre-determined enumerated knowledge includes: for a wedding, videos/images/sound recording are all needed; for a meeting, audio is satisfactory. Further, a human is allowed to supply such knowledge.

Step 1300 is solicitation of devices. A solicitation is initiated by the server, or by device A. The initiation by the soliciting party is referred to “triggering”. The solicitation is transmitted to the solicited party, such transmission can go through the server, or directly goes from the soliciting to the solicited. The solicited party can decide to agree to, disagree with, accept with contingency, ready to negotiate, or not respond. The solicited party can in turn initiate a solicitation, thus the solicitations form a cascade, referred to as “cascading triggers”; such triggers form a neighborhood of devices knitted by the triggers.

A solicitation contains requirements for availability, capacities, location, timing, and duration for gathering data by the solicited device. The solicitation can also contain proposed financial payments, or even promised punishment for rejection.

One contemplated solicitation contains request for gathering data by the solicited device at a specific location in a future time.

Step 1310 is where a solicitation is initiated. The solicitation can be initiated by the server, or by device A in FIG. 1. The server initiates a solicitation because (1) from time to time, devices update the server their location, distances, orientation, capabilities, timing, availability, and other characteristics; (2) the server based on the updates can decide automatically which device is gathering the most valuable data at the moment, and (3) the server decides which devices can be solicited to help, based on a utility function. The utility function is contemplated to assign a linear score to each of the location, distances, capabilities, availability of a device's. Many forms of the function are possible.

A solicitation can also be initiated by a device. A device is said to be performing “triggering” when it initiates soliciting of other devices. This occurs either through positive action by a human through a human-machine interface accessible the device, or automatically by an algorithm that utilizes sensors to identify an important event. The triggering device in one contemplated situation will activate all other devices within a defined range of users, physical area, and/or time (e.g. devices within 300 feet, and devices that are in that space within 30 seconds, or users that are connected to the triggering device's owner, but not necessarily within a given physical proximity, or all three). As a consequence, devices in vehicles can activate devices on pedestrians, and vice versa, and these triggers can have different standards for private groups or public access.

A trigger can be automatically generated, and some of the circumstances where a trigger is automatically generated are listed below: (1) significant deceleration or acceleration, 3Gs (about 30 m/s/s) is a threshold value, and a sensor for linear acceleration is preferred, (2) significant turning acceleration, (3) weaving or excessive lane changes, (4) traveling faster than X mph, (5) rolling stops, (6) violent cursing or expressions of fear, (7) texting on cellphone, (8) loud music, (9) meteors, and (10) sighting of a celebrity.

In one embodiment, a device while capturing video of a target, solicits a nearby camera to capture “−M, +N seconds”, namely the solicitation asks the solicited camera that the past M seconds of video is valuable, and if the camera has such video, it should try to keep the video in face of limited storage, and also that the future N seconds is valuable, so the camera within its capacities and availability should treat it as priority in capturing the future N seconds of video.

Step 1320 depicts a method for a solicited device to process a solicitation, and for the soliciting device to try solicitation future in the situation where a solicited device is not willing to help. In this example, the solicited device can act in any of the following manners: (1) agrees to the solicitation; (2) agrees to the solicitation with contingency. Contemplated types of contingency include delays in availability, receipt of financial payments, and reduced quality in data gathering; (3) disagree to the solicitation; (4) disagree to the solicitation with contingency; (5) being silent to the solicitation, and (6) being silent to the solicitation with contingency.

Just like in Uber™, the soliciting party can try harder in solicitation. Some contemplated measures include: increasing financial payment to the owner of the solicited device, decreasing the demand on the availability of the device, and “blackmailing” the unwilling device with future uncooperative behavior.

Step 1360 is the creation of a neighborhood of devices by “cascading triggers”.

A stakeholder is the server or a device in FIG. 1. A neighborhood contains at least two stakeholders; the typical purpose of creating a neighborhood is for gathering data. The multitude stakeholders involved are called a neighborhood.

The server facilitates the creation of neighborhood in the following general steps: A stakeholder creates a trigger, a trigger being a command; and a trigger can be created manually by a person, or automatically by a device; the stakeholder is called the “prime stakeholder”. The trigger is sent, assisted by the server, to at least one another stakeholder. The stakeholders being sent the trigger is called neighbor to the prime stakeholder. The trigger received by a neighbor typically asks the neighbor to take an action, the action by default being data capturing.

A user (a pedestrian, for example, and perhaps a teenager or millennial) would want to create groups of their friends (perhaps different groups for different purposes) such that when they “activate” the group, then certain of the sensors on the smartphones of each of the members are automatically turned on by this user, and then they collectively engage in some experience or activity. So easy creation, acknowledgement of membership, and activation of these friend groups is desirable.

A neighbor in a neighborhood (without loss of generality called “the first neighborhood”) could initiate a trigger, thus becoming another “prime stakeholder”, reaching its neighbors, and thus forming a neighborhood (called “the second neighborhood”). A stakeholder might belong to both the first neighborhood and the second neighborhood. Still another stakeholder could initiate a trigger, creating the third neighborhood. More triggers can initiate, and more neighborhoods are created. The union of the neighborhoods might eventually reach all stakeholders, or in other cases, reach a subset of all stakeholders. This process can continue for a number of iterations defined in software and by individual users. Capping the number of triggers within a period of time helps to limit the number of nuisance triggers a hacker or an annoying person might generate.

Some of these triggers overlap in time, thus the following method is contemplated for managing the keeping of useful data on devices and possibly on the server. In one embodiment, when an event occurs (user-initiated, or initiated when certain conditions are met), a solicited device is asked to store −M and +N seconds of video, that is, M seconds of video before a specified time, and N seconds after that specified time. That much video is captured, and put into a store while the device still continues the looped video. This occurs both on the soliciting device and on the solicited devices. Now, it is possible for one of the solicited devices to initiate another solicitation requesting for a −M,+N capture which overlaps the first soliciting device's solicitation. In general up to K such solicitations can overlap. Each of these solicitation will be transmitted to the server as separate entities, and stored as such, i.e., as events of interest. Note that if all these −M,+N captures are done, all the captured videos are “relevant” since they are already grouped into the full set of relevant videos.

Such soliciting of devices is a form of resource sharing of communications, viz, dedicating an expensive resource (digital communication bandwidth, or an automobile, or a bedroom) which is almost never used, should be shared with others when the “owner” is not using it (message switching, packet switching, Uber, AirBnB™).

Step 1380 deals with contention during solicitation. For example, contention arises when there are 100 devices (D1-D100), and D1 and D10 each want to use competing sets of other devices.

The solutions involve a priority scheme. Parts of the priorities are set a priori, and other parts of the priorities are dynamic. Some priorities are built into the system, for example, ID assigned to each device. In general, there are four ways to revolve a contention, and all are contemplated for resolving the contention: (1) to queue, (2) to share, (3) to block and monopolize, and (4) to smash, as in two contenders collide, both fail, and try again after randomized time outs in the case of the Ethernet protocol. For more treatment on such priority schemes, see Priority Queueing in the book Queueing System by Leonard Kleinrock.

Step 1400 is a method in managing changes in membership in the neighborhood based on ranking of benefit of contribution. A member in the neighborhood is likely to be kept if its benefit of contribution is ranked high; a member is likely to be dropped if otherwise. Some of the ways of determination include: (1) if a device is too far away to achieve good quality in sensing, then the benefit is low, (2) if there are enough number of other devices contributing, an additional device will have low contribution. (3) financial payment being offered is ranked high, (4) rank high when different types of sensory data are asked for, for example, at a moment, an audio recording is needed to fill a blank, thus it ranks higher than a second video camera, (5) whether the device is able to maneuver to the better position, orientation, in order to capture the sensing data; in one contemplated scenario, the devices are not self-motive thus the devices cannot get to where the soliciting device wants them to go, for example, the owner of the phone is sleeping, or otherwise ignores instructions to move.

Step 1500 is where a device (or the server) gives advice to solicited devices on gathering additional perspectives. When device A solicits device B, a solicitation is provided with device B, and what is in the solicitation broadly falls into the category of location, setting for sensing, and utilization of capabilities. Once device B agrees to the solicitation and starts gathering data, device A can continually provide advice to device B; a piece of advice could be moving to another location, panning device B's camera, pointing the camera to certain directions, changing the settings of audio recording, increasing the frequency of sampling, among other possibilities.

In one contemplated embodiment, device A contains a software application which is capable of calculating a “difference value” of two images. Device A solicits device B, which provides images as an additional perspective of a target. Device A's software application calculates the difference value of the current image taken by itself and the current image taken by device B. Device A then advises device B to move to a new location in order to reduce the difference value.

In one preferred embodiment dubbed “sticks for 3D selfies”, a person holds 2 contemplated selfie sticks, each stick has a mobile phone mounted. A stick has a slider, and the mounted phone can move along the slider. A stick also is couple with a software application, thus is able to communicate with the phone to receive instructions on sliding motions. The person starts the first phone to take a series of selfie photos. While taking the photos, the first phone solicits the second phone, which agrees to the solicitation and also starts taking photos. The first phone advises the second phone on moving for certain amounts of distance, and the second phone instructs the slider on its stick to move the distance. After a period of time, the gathering of data is done, and the second phone sends photos to the first phone which acts at a collector. In an alternative embodiment, the second phone takes a video instead. In still another embodiment, the second stick is mounted a GoPro camera.

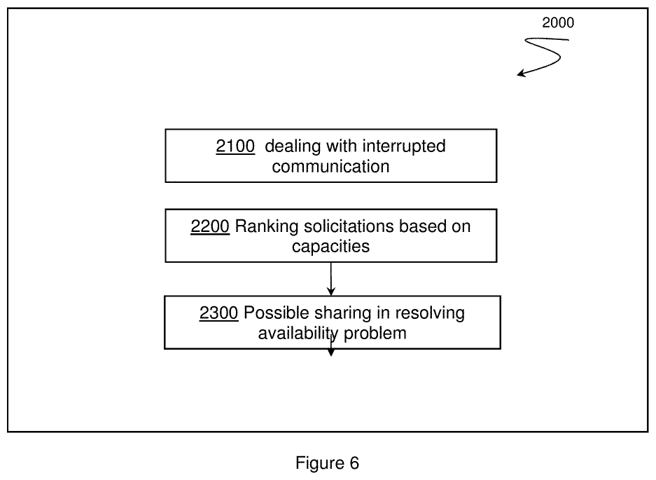

FIG. 6 are methods 2000 that collectively help a device deal with problems associated with its availability.

Step 2100 deals with interrupted communication. A device that has been in contact becomes not being able to be reached, or first reached and then lost, or reached in the middle of an event. If the device has completed the receipt of a solicitation, then it can proceed until the next moment when communication is needed for, for example, sending its own solicitation. If the device has not completed the receipt of the solicitation, then it can ignore it, and continue to do whatever it has been doing before the interrupted communication.

Step 2200 is ranking of solicitations based on the availability and capacities of the solicited device. Any of the capacities of the device can be a factor in ranking solicitations. This step works with Step 1380 above. The solicited device should provide its availability to the soliciting device, partially based on its then and anticipated capacities, in relation to expectations contained in the solicitation. For example, when battery is running out, the device cannot satisfy expected high resolution. For one example: the device's battery is running out in 5 minutes, however, the solicitation requires data expected to last only 1 minute, so this device should agree to the solicitation. Further, potential near-future emergence of solicitations should be considered, so that the device might be able to agree to the next solicitation with the remaining battery life.

Step 2300 considers sharing as a way of resolving contentious multiple solicitations. There are cases where the same device can satisfy multiple requests simultaneously, for examples, (1) the same device having multiple capabilities in audio, video, and images, and (2) the same video can serve two solicitations, both asking for the same chunk of video.

FIG. 7 are methods 3000 that collectively help a device deal with problems associated with its capacities.

Step 3100 manages batter life. For a typical device, when gathering data, the device is not plug in power, thus its battery supplies all the needed energy. All aspects of data gathering costs energy, and such costs are prioritized so that batter life can achieve more value. When battery is low, certain functions are turned off according to a priority list, for example, on the list Bluetooth is turned off before 3G is turned off.

Step 3200 applies to the case of an ad hoc network. A device could free up its local storage by transmitting its data onto another device on the ad hoc network.

Step 3300 contains methods of adaptively sending data to the collector.

Some of the solutions are implemented in the prototype system developed as a preferred embodiment of this invention.

Contemplated methods include: (1) when wi-fi is available, upload data in its full resolution to the collector; (2) when wi-fi is not available but data (3G, 4G, GPRS etc) is available, upload data in less resolution, and later upload the full resolution when wi-fi is available; (3) in streaming, when there are multiple devices streaming data to the collector, the collector allocates bandwidth according to perceived value of data from different devices; such ranking of value is first accomplished during solicitation, and the ranking can be modified by human intervention through a human-machine interface at the collector.

Some implementations provide an interface such as an application on a smartphone operating system that provides a user-friendly interface in which the user will control their device's connection with the server, making choices as to which kinds of data the smartphone will upload, as well as any bandwidth limits. Much of the determination of what is uploaded is automatically computed. Pre-processing, an optional step, creates metadata and data content from a piece of data. Typically metadata is of small size, especially compared with “data content”. For example, from the data of an image, there could be created the metadata of the location, the maker of the camera, the timestamp, and the “data content” of pixels of the image. To facilitate finding relevant sensor data more findable, the system will combine locally produced metadata with other attributes suggested by the local device's user, as well as what it can infer from its own analysis of the data and that of nearby devices.

Some implementations contain: (1) software to easily upload sensor data from device to the server that storage, computation, and marketplace services. The smartphone case is an app available through application stores (e.g. Google Play™, Apple's App Store™). (2) an interface that allows the smartphone to connect over wi-fi or other internet access medium (i.e. Bluetooth) to The collector servers, and re-connect automatically with broken connection, and use public access points opportunistically, and (3) distributed triggering of sensor data to reduce bandwidth, storage, and processing requirements.

In addition to the intelligent determination of upload rates, some devices such as smartphones can store data locally and upload only when so requested to by the collector. Maximum rates of ongoing upload can be set by the device owner. When a potential customer notices or is involved in an event for which they would like to purchase pertinent pertaining data, they will inform the collector through a website, SMS system, or other easy method. (The more of these such notifications received for a single event, the more the collector will trust them.) Based on this notification the collector will instruct nearby devices to increase their upload rate, or, in the case of devices set to significant local storage, prioritize storage of data identified as significant by the notification to the collector.

With some implementations: (1) A car is not likely to be on the road for more than 1-2 hours per day before it reaches a point where it can find good connectivity (at home, in a garage, or at the office building), (2) The collector can make the frame rate dynamic based on: motion in the scene that the camera is recording, speed of the car itself, and this might reduce the frame rate to about an average of 3 fps; (3) the collector can cut down the resolution as well, also based on the two factors above (perhaps down to an average of 1 megabit/frame). The considerations above can cut down the bandwidth and storage from a pessimistic of 100 mbps and 360 Gbytes/hour by a factor of about 100 which gives: (i) 1 mpbs, (ii) 3.6 Gbytes/hour, and also (iii) a daily storage requirement of about 7.2 Gbytes/day. However, there is another possibility that can be much more effective and it is the following: (a) one needs only send the metadata (location and time) of the vehicle up to the collector's database. This is a very small amount of data, (b) While that is going on, the camera is recording images based on the reduced requirements above, (c) However, the storage on the vehicle could overflow and write-over some earlier data and that might be data we need. So the collector needs to get the metadata up to the drone database quickly; and the methods include but are not limited to: (1) Whenever a car is in motion, that means that there is a driver in the car, and we know with very high probability that the driver has a connected cellphone with him/her that can talk to the cloud over their carrier network, (2) So all one has to do is to load an app on the cellphone as well as on the camera which allows them to talk with each other via Bluetooth, for example, (3) Then the metadata can be sent continuously from the sensor through the cellphone to the collector's database, (4) Now, when some buyer calls in The collector that they need some image data (e.g., they were involved in an accident), The collector's database is contacted, and the database sends a message to all sensors that have image data of interest (which the database can figure out using its AI capabilities), (5) The message tells each sensor of interest which portion of its captured data is should NOT overwrite, and (6) Then, the relevant data can be sent up immediately (using the cellphone access) or later when the drone gets within WiFi access.

The net result is that very little bit of the cellphone bandwidth is used to communicate (two-way) between the sensor and The collector database. Also, the sender only needs to upload images that have been requested and still handle the load.

There is no question that large volumes of data present difficulty even when bandwidth and processing power are growing exponentially over time. The “send me the track first” approach clearly is a start, and the collector can ask the user to store his/her video on YouTube first before the collector calls for the video. In addition, distributed computing can be employed, so that the user's phones do some computation while the data has not been uploaded yet. For legal issues in traffic accidents—a ‘fast’ phenomena that requires the collector to explain—5 fps (frames per second) would do. Also with some compression 5 megabits per frame is sufficient for upload. That alone makes the collector's data center much more doable. What, then, is the collector aiming for? There are at least two major areas: 1) events where people know they'll want a certain kind of viewable record, like a conference, and 2) the minimum amount of information required to have reliable understanding of an event. In the latter case, the “5 fps×5 megabits per frame” estimation is reasonable. The other thing to consider is that the collector has intelligent control of how much is uploaded, and how much the upload is compressed. A lot of this can use local processing. (This is reminiscent of the ‘triggering’ that had to be done extensively in high energy physics in the 1970s and 1980s, where data had to be removed before it was even recorded, because so much was being generated so fast.) Below are two examples of how that might work, the “semi-smart” and the “really smart”: (1) The semi-smart: if there's no movement or change in input at all in a frame, the device can, with instruction from The collector cloud, drop its upload to 0.5 fps and a low resolution. Scenes with zero movement, especially during low traffic periods at night, are a place where it can save huge bandwidth and processing, and help subsidize active areas. Same with when the audio drops to just background noise, or a heart rate is constant; (2) The really smart: this relates to Google's PageRank, but for multiple types of data and multiple types of relationship. Consider a single data source that is linked by time, location, or other metadata attributes to four other sources. If the four other sources are highly active, but for some reason the data source in consideration isn't, then this fact gives the collector a reason to increase the bandwidth from it, the ‘rank’ of the nearby data would communicate to the collector that this node under consideration is, in fact, more important than it knows from its own data. Conversely, if a single node is telling the collector that it is very important, but linked nodes (other data sources) are claiming that it isn't very important, then the collector cloud can make it send less information. This points to a way developing trust in what nodes report in distributed routing.

Considerations for the storage of data and processed data include but are not limited to: (1) All data can be replicated and stored in distributed manner; (2) Metadata and content might not reside physically next to each other, (3) A piece of content might be turned into multiple segments; These segments do not necessarily reside physically next to each other, and (4) Physical locations of data (including all of the above) might be re-arranged from time to time, in order for better response time, savings on physical storage space, etc. For example, a large video often being inquired by people in New York City might be moved to a database that has the fastest response time to inquiries from New York City.

Data collected before and after the trigger (for example, M seconds before the trigger's time, or N second after the trigger's time) are typically considered has more value than otherwise.

Centrally, the collector can intelligently determine the value of a device's data, based on analysis of data attributes across the system. For example, the most frequently purchased data will have a range of attributes—location, distance from landmarks, amount of movement, time of day, etc.—that will allow the system to intelligently predict the value of the data that could be uploaded by a given device, and modify the upload rate based on that prediction. When data is not being uploaded, devices will still update the system with metadata attributes of what they are recording. Similarly, if nearby devices are, by their local knowledge, producing valuable data (for example, in a video feed they could be detecting a large amount of movement), the system could determine that a device near those other devices should begin uploading at a rate faster than its own determinations suggest.

FIG. 8 depicts the forming of an ad hoc network among devices where different devices use method 4000 of creating or joining an ad hoc network. With the method, devices could communicate directly with each to form ad hoc communication network, e.g., one of them has land line or other good connection, while others are all block from using cellular. The solution belongs to the general question how to form an ad hoc network; alternatively, one device acts as the hot spot.

Many methods have been proposed for setting up ad hoc communication networks for generic devices. Some of the methods can be used in implementing parts of method 4000. Step 4010 comprises providing the first device a way of communicating with the second device so that the two are communicating. Step 4020 comprises finding out whether device A and device B eventually will create a new network, or one of them joining an existing network. Step 4030 comprises creating a new network that contains device A and device B only. Step 4040 comprises letting device A joining an existing network of which device B is part. During the setup and usage of the ad hoc network, the devices use any of its communication capabilities, some of which are explained in FIG. 4.

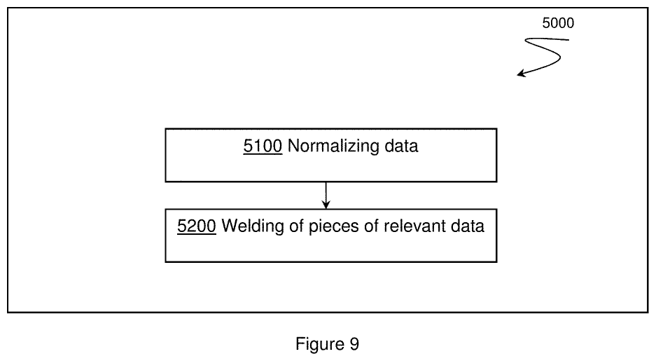

FIG. 9 illustrates the processing of data after data is gathered.

Step 5100 is normalization of time information and location information, e.g., solving problem caused by time delays cause problems when stitching together images and sound. Nowadays, all devices are synchronized (e.g., all synced to the Naval clock). If the devices are not synchronized, contemplated methods include: humans can help; cues/clues from the photos, sounds that mark the start of someone's talking, etc.

The normalized form for a piece of data, and the associated methods, are contemplated: (1) The location information contained in the metadata is being normalized so that the best possible resolution is obtained, and recorded in a form that is consistent across all location information. The methods include but are not limited to: converting all location information to the best possible GPS resolutions, converting all location information into the most accurate (x,y,z) coordinated in the space, computing the location information of a piece of data based on another pierce of data of known relationship (for example, the location of the first piece of data is precisely 1 meter forward on the z-axis to the location of the second piece of data, recognizing location information contained in the data content (e.g., the data content is an image captured by a satellite), (2) The time information contained in the metadata is being normalized so that the best possible resolution is obtained, and recorded in a form that is consistent across all time information. The methods include but are not limited to: converting the time information to the best possible precision, converting all time information into one particular format, computing the time information based on the time information of another piece of data when the time relationship between the two pieces of data is known, recognizing time information contained in the data content (e.g., the data content is an image and in the image there shows a clock); and (3) Additional metadata is normalized; the methods typically involve the using of the corresponding catalogs of the types of the metadata, and the standard vocabulary associated with such catalogs.

It has been contemplated a catalog of metadata, data content, processed data, the catalog includes but is not limited to: (1) Metadata and data content of a piece of data; (2) Metadata includes but is not limited to: the location information, the time information, types of data, information about the sensor, information about the environment of the sensor, information about the device, information about the speed of the device, information about the environments of the sensor, additional information on the history of how the data has been captured, stored, and transmitted. (3) The Spacetime model (reference: the Wikipedia page on “spacetime”) can be used in describing location information and time information. A “specific spacetime” can be a point or multiple points, a line or multiple lines, a plane or multiple plane, a region or multiple regions, or a set of the above. (4) Information or knowledge that is injected, deduced or otherwise created including but are not limited to ontology, knowledge base, updates to knowledge, knowledge created after machine learning; (5) Inquiries are also saved and stored on the server, and become data residing on the server. (6) Multiple types of sensor data is stored in The collector cloud with extensive metadata: (i) metadata such as modified exif tags that anonymize the metadata and incorporate it with user-created metadata and metadata our own algorithms create, with AI-assigned levels of trust, (ii) video footage comes with time and date stamp, as well as technical characteristics of video (frame rate, resolution), (iii) the collector can compare GPS data to topographical maps to get accurate elevation data, (iv) user optionally provides further information: what video is capturing, if there are people in the field of vision, flight path and estimated elevation if known (for drones); what the event is (similar to hash tagging), (v) The collector AI also performs content analysis and compares with user information (which is not necessary, but improves marketability of data), (vi) The collector scans for alphanumeric codes to search (license plates, signs, etc.) face density, speed of traffic, etc., (vii) The collector AI comes to decision about amount of people, type of scene, weather, amount of traffic, which alphanumeric codes in data, etc., (vii) all of this is coded into metadata, (viii) extensive metadata is used in making user easily searchable in new ways (detailed below in marketplace), (7) The data will not be anonymized in that the exif/metadata will be retained, however, the identity of the account holder will be protected; this will protect privacy and also prevent going outside of the collector to arrange cheaper payments, (8) As another related feature, since a device should be able to measure a vehicle's speed, then the frame rate of the camera could be adjusted to slow down when the vehicle is moving slowly. For example, when one stops to park on the street (or overnight) or in the apartment complex garage, then the frame rate could be dropped down to a minimum (providing garage or street protection) but not zero since it continues to act as surveillance. On the highway, it could go up to the 30 fps (note, a vehicle moving at 60 mph goes at 88 ft/sec, so 30 fps covers motion every 3 ft or so (but that is too high for city traffic). (9) A note on how general the data can be: A piece of data could be a scene from a novel, for example, a scene from the novel Ulysses contains metadata of location and time, and the location of a scene can well be related to a traffic condition occurring in today's Dublin.

Step 5200 is method for “welding” pieces of relevant data. Two pieces of data are welded if they fall in a specific spacetime, and this “welding” can be recursive.

Two piece of data are candidates for being welded, because they are relevant in the following sense: based on the idea that one user/platform triggers nearby, or related platforms to capture data (and understand the “nearby” or “related” can mean that the triggered platforms need not be those that are within a certain distance of the source, but can be related some other way, such as in a common community, friends, etc., i.e., the definition of “distance” can be feet, cost, community, similarity, etc.

Two pieces of data collected through collative gathering by multiple devices are candidates for being welded. Irrespective of when the other devices are contacted to provide their additional perspectives, the devices can provide their information to the collector concurrently, or in any suitable sequence or time frame. Thus, it is contemplated that a dash cam on an automobile might “see” a car accident, and solicits additional perspectives from nearby dash cams. The various perspectives from the other dash cams can then be received by a collector, and then mosaicked by the collector or some other device. In another example, a cell phone being used by a participant in a birthday party might “see” someone blowing out a birthday cake, and solicit additional perspectives from nearby cell phones. Such solicitation might be initiated by the user of the soliciting cell phone, or might be initiated by the soliciting cell phone autonomously from its human user. As in the other example, the various perspectives from the various cell phones could then be received by a collector, and then mosaicked, stitched together in a 3D virtual reality image, or combined in some other manner by the collector or some other device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of capturing multiple data sets regarding a target from different perspectives, comprising:
identifying, by a mobile device A, a target;
gathering, by the mobile device A, a first data set of the target from a first perspective based on the identification of the target;
soliciting, by the mobile device A, a mobile device B to provide a second data set of the target from a second perspective;
providing, by the mobile device B, the second data set corresponding to the second perspective to at least one of the mobile device A and a server;
soliciting, by the mobile device B, a mobile device C provide a third data set from a third perspective; and
providing, by the mobile device C, the third data set to at least one of the mobile device A, the mobile device B, or a server; and
issuing, by the mobile device A and to at least one of the mobile device B or the mobile device C, an operating instruction based on the corresponding at least one of the second data set and the third data set.

2. The method of claim 1, further comprising, prior to the soliciting by the mobile device A:
providing, by the mobile device B and to the mobile device A, at least one of a location, availability, distance, orientation, or capability of the mobile device B; and
wherein the step of soliciting by the mobile device A further comprises soliciting, by the mobile device A, the mobile device B to provide the second set of data of the target in the second perspective based on at least one of the location, availability, distance, orientation, or capability of the mobile device B.

3. The method of claim 2, wherein mobile device B provides the at least one of the location, availability, distance, orientation, or capability of the mobile device B to the at least one of the mobile device A or the server after receiving a broadcast from the mobile device A.

4. The method of claim 2, wherein mobile device B provides the at least one of the location, availability, distance, orientation, or capability of the mobile device B to the at least one of the mobile device A or the server before receiving a broadcast from the mobile device A.

5. The method of claim 1, wherein mobile device B comprises a dash cam on a vehicle.

6. The method of claim 1, wherein the target comprises a vehicle accident.

7. The method of claim 1, wherein the server is internally located in at least one of mobile devices A, B, or C.

8. The method of claim 1, further comprising, following the step of gathering the first data set of the target:
executing, by the at least one of the mobile device A and the server, a delay of a predetermined amount of time prior to soliciting mobile device B.

9. The method of claim 1, wherein the step of soliciting, by the mobile device A of the mobile device B comprises:
sending, by the mobile device A, a signal to mobile device B;
receiving, by the mobile device A, information from mobile device B; and
determining, by the mobile device A, that the mobile device B can provide the second data set of the target from its perspective based on the received information.

10. The method of claim 1, further comprising:
gathering, by the mobile device B, the second data set of the target in response to the solicitation; and
providing, by the mobile device A, recordation advice to the mobile device B while the mobile device B is gathering the second data set.

11. The method of claim 1, wherein the mobile device B is solicited before the mobile device C is solicited by a predetermined amount of time.

12. The method of claim 1, further comprising stitching together, by the server, the first, second and third data sets.

13. The method of claim 1, further comprising allocating, by the server, of a payment of funds to at least one of the mobile devices A, B, and C for providing their data sets.

14. The method of claim 1, wherein the second and third perspectives are respectively captured by the mobile device B and the mobile device C at a future time and location specified by the mobile device A or the server.

15. The method of claim 1, wherein the step of issuing an operating instruction comprises at least one of:
changing a sampling rate;
changing a resolution;
changing a transmission rate;
issuing an overwrite protection order for at least a portion of captured data;
changing in location;
initiating a panning motion; or
pointing in a different direction.

16. The method of claim 1, further comprising:
receiving, by at least one the mobile device B or the mobile device C, at least one additional solicitation; and
resolving, by the at least one of the mobile device B or the mobile device C and via a priority scheme, a contention caused by the multiple received solicitations.

17. The method of claim 16, wherein the priority scheme comprises at least one of a device ID scheme, a queuing scheme, a sharing scheme, a block-and-monopoly scheme, or a smashing scheme.

18. The method of claim 1, further comprising:
limiting, by at least one of the mobile device A or the mobile device B, an amount of solicitations that can be sent by the respective at least one of the mobile device A or the mobile device B to a predetermined number of solicitations over a predetermined amount of time.

19. A system for capturing multiple data sets regarding a target from different perspectives, comprising:
a first mobile device programmed to:
identify a target;
gather a first data set regarding the target from a first perspective based on the identification of the target;
solicit a second mobile device to provide a second data set of the target from a second perspective;
the second mobile device programmed to:
receive the solicitation from the first mobile device;
gather the second data set;
provide the second data set to the first mobile device; and
solicit a third mobile device to provide a third data set of the target from a third perspective;
the third mobile device programmed to:
receive the solicitation from the second mobile device;
gather the third data set; and
provide the third data set to at least one of the first mobile device, the second mobile device and a server; and
wherein the first mobile device is further programmed to issue an operating instruction to at least one of the second mobile device and the third mobile device based on the corresponding at least one of the second data set and the third data set.

20. The system of claim 19, wherein the second mobile device is further programmed to determine whether or not to determine if the third mobile device can provide a third data set of the target from the third perspective.

21. The system of claim 21, wherein the second mobile device is further programmed to:
decline to provide the second data set to the first mobile device; and
agree to solicit the third mobile device, wherein soliciting the third mobile device comprises:
sending a signal to the third mobile device;
receiving information from the third mobile device; and
determining whether the third mobile device C can provide the third data set of the target from the third perspective based on the received information.

22. The system of claim 19, wherein the second mobile device is further programmed to:
agree to provide the second data set to the first mobile device; and
decline to solicit the third mobile device.

23. The system of claim 19, wherein the second mobile device is further programmed to:
decline to provide the second data set to the first mobile device; and
decline to solicit the third mobile device.

24. The system of claim 19, wherein at least one of the second mobile device or third mobile device is programmed to:
receive at least one additional solicitation; and
use a priority scheme to resolve a contention caused between the multiple received solicitations.

25. The system of claim 24, wherein the priority scheme comprises at least one of a device ID scheme, a queuing scheme, a sharing scheme, a block-and-monopoly scheme, or a smashing scheme.

26. The system of claim 19, wherein at least one of the first mobile device or second mobile device is further programmed to:
limit an amount of solicitations that can be sent to a predetermined number of solicitations over a predetermined amount of time.

27. The system of claim 19, further comprising wherein:
the second mobile device is further programmed to:
provide, to the first mobile device, at least one of a location, availability, distance, orientation, or capability of the second mobile device; and
wherein the first mobile device programmed to solicit the second mobile device further comprises the first mobile device programmed to:
solicit the second mobile device to provide the second set of data of the target in the second perspective based on at least one of the location, availability, distance, orientation, or capability of the second mobile device.

28. The system of claim 27, wherein the second mobile device is programmed to provide the at least one of the location, availability, distance, orientation, or capability of the second mobile device to the at least one of the first mobile device or the server after receiving a broadcast from the first mobile device.

29. The system of claim 27, wherein the second mobile device is programmed to provide the at least one of the location, availability, distance, orientation, or capability of the second mobile device to the at least one of the first mobile device or the server before receiving a broadcast from the first mobile device.

30. The system of claim 19, wherein second mobile device comprises a dash cam on a vehicle.

31. The system of claim 19, wherein the target comprises a vehicle accident.

32. The system of claim 19, wherein the server is internally located in at least one of the first mobile device, the second mobile device, or the third mobile device.

33. The system of claim 19, wherein the first mobile device is further programmed to, following the step of gathering the first data set of the target:
execute a delay of a predetermined amount of time prior to soliciting the second mobile device.

34. The system of claim 19, wherein the first mobile device programmed to solicit the second mobile device further comprises the first mobile device programmed to:
send a signal to the second mobile device;
receive information from the second mobile device; and
determine that the second mobile device can provide the second data set of the target from its perspective based on the received information.

35. The system of claim 19, further comprising:
wherein the second mobile device is programmed to gather the second data set of the target in response to the solicitation; and
wherein the first mobile device is programmed to provide recordation advice to the second mobile device while the second mobile device is gathering the second data set.

36. The system of claim 19, wherein the second mobile device is solicited before the third mobile device is solicited by a predetermined amount of time.

37. The system of claim 19, wherein the server is programmed to stitch together the first, second and third data sets.

38. The system of claim 19, wherein the server is programmed to allocate a payment of funds to at least one of the first, second or third mobile device for providing their data sets.

39. The system of claim 19, wherein the second and third perspectives are respectively captured by the second mobile device and the third mobile device at a future time and location specified by the first mobile device or the server.

40. The system of claim 19, wherein the step of issuing an operating instruction comprises at least one of:
changing a sampling rate;
changing a resolution;
changing a transmission rate;
issuing an overwrite protection order for at least a portion of captured data;
changing in location;
initiating a panning motion; or
pointing in a different direction.
